(19) United States
(12) Patent Application Publication
(10) Pub. No.: US 2002/0128864 A1
(43) Pub. Date: Sep. 12, 2002

(54) Computerized information processing and retrieval system

(76) Inventors: Christopher T. Maus, Sagle, ID (US); Jackson B. Connolly, Post Falls, ID (US)

Correspondence Address: GARDNER GROFF, MEHRMAN & JOSEPHIC, P.C., Paper Mill Village, Building 23, 600 Village Trace, Suite 300, Marietta, GA, 30067, US

(21) Appl. No.: 09/799,479

(22) Filed: Mar. 6, 2001

(51) Int. Cl. G06F 17/60

(52) U.S. Cl. 705/2

(57) ABSTRACT

A computerized information processing and retrieval system is described. The system includes a data acquisition device that collects various types of data. After collecting the data, this device transfers the data to a data accumulation device. The data accumulation device effectively stores and transfers data between digital devices. Finally, a computer system processes the data stored on the data accumulation device, retrieves any relevant information, and produces a report for a user. Consequently, this multipurpose system includes components easily adaptable to numerous applications such as wellness monitoring, emergency medical treatment, financial planning, an informational resource system, inventory management, management of service providers, as well as other suitable applications. The computerized information processing and retrieval system easily adapts into a wellness monitoring system that can track fitness, nutrition, medicine, blood-lipid levels, as well as other values. As a medical treatment system, the computerized information processing and retrieval system enables more effective treatment of patients in either an emergency vehicle or a medical facility. Another application of the computerized information processing and retrieval system includes an informational resource system that efficiently retrieves detailed information associated with a simple informational identifier.

### CROSS REFERENCE TO RELATED APPLICATIONS

This patent application relates to commonly owned U.S. patent application Ser. No. 09/436,323 filed on Nov. 8, 1999 entitled Health Monitoring and Diagnostic Device and Network-Based Health Assessment and Medical Records Maintenance System, which is herein incorporated by reference.

### TECHNICAL FIELD

The present invention relates generally to the field of automated information retrieval systems. In particular, it relates to a computerized information processing and retrieval system that uses a data accumulation device, such as a smartcard, produces wellness reports when used as a wellness monitoring system, displays critical medical data when used as an emergency medical treatment system, and retrieves detailed information when used as an informational resource system.

### BACKGROUND OF THE INVENTION

Amidst a technologically advanced society, the quest for convenience continues. From busy professionals to “stay at home” parents, individuals of all types can appreciate the timesavings resulting from greater convenience. Savings in time can result in greater efficiency and productivity, which may result in greater cost savings. Moreover, saving time can substantially relieve some stress associated with hectic schedules. The widespread use of computers results in greater convenience by simplifying some tasks. However, other tasks still demand considerable human effort and lack the convenience available through computer use.

Wellness monitoring remains a task that warrants considerable effort from the patient. Typically, wellness monitoring involves the patient enduring a discourse from a physician that details a targeted fitness regimen, dietary regimen and medicinal regimen. To some degree, the physician may indicate the manner in which these directives can integrate into the patient's daily activities. However, the patient satisfies and monitors compliance with these directives. For example, one directive may demand that the patient record food consumed daily. Consequently, the patient may record dietary intake and medicinal intake associated with each meal of the day in a diary. This record could include noting the number of calories consumed per day and the corresponding insulin dosage. To record each meal, the patient must carry the diary around or risk forgetting an entry. In addition, placing each entry in the diary requires time. Moreover, recording each exercise regimen requires additional time and effort separate from the nutritional records. Furthermore, the patient spends time assessing progress by qualitatively analyzing these records. For a busy patient with a hectic schedule, completing these inconvenient tasks can be tedious and frustrating. The absence of an effective monitoring mechanism exacerbates the problem by not motivating compliance. This inconvenience can make long-term compliance with physician's recommendations impractical. As a result, the patient may monitor intake and fitness less thoroughly. Consequently, the patient's health could suffer from the lack of a convenient wellness monitoring system.

In addition to wellness monitoring, medical treatment systems for use in emergency situations demand considerable effort of emergency personnel in acquiring medically relevant information. Typically, medical personnel such as paramedics and emergency medical technicians respond to emergency calls. Often, these medical professionals arrive at the emergency site with minimal knowledge about the victim. For example, a dispatcher may indicate that an elderly woman is unconscious. As these professionals enter the trauma site, they may begin the time consuming task of asking observers about the woman's medical history. Medical professionals may spend considerable time attempting communication with an observer consumed with the unconscious patient's present condition. Unless they receive answers, they may speculate about the patient's medical history. However, this speculation could result in an additional loss of time. For example, medical personnel could speculate that the unconscious patient is not allergic to a particular medicine. However, they may modify treatment after the patient's reaction to the medicine indicates that the patient is allergic. These time losses could delay stabilizing the patient. Consequently, the health of a critical patient could be further jeopardized.

Finally, information retrieval systems still rely on the considerable effort of the user and consequently lack some of the convenience computer's can provide. For example while at a dinner party, an individual may hear of a company with great investment opportunities. In response, this individual may note the company's ticker symbol with the expectation of retrieving additional information about the company in the future. After some time, the individual may search for information on the company. This search may begin with the individual collecting the stored ticker symbol. After finding the ticker symbol, this person can begin retrieving the company information using a computer. Though the individual retrieves the company information with a computer, the individual often spends time examining the search results, narrowing the search, or broadening the search as desired. This search refinement can require considerable time and result in missed financial opportunities. Consequently, this lack of convenience could adversely affect the individual.

Despite the development in the area of information retrieval systems, conventional solutions fail to provide a feasible and convenient solution for efficiently retrieving information and minimizing manual involvement. Thus, a need still exists for a convenient computerized processing and retrieval system that can be used in wellness monitoring, emergency medical treatment, and information retrieval systems.

### SUMMARY OF THE INVENTION

The present invention meets the needs described above in a computerized information processing and retrieval system. This multipurpose system includes components easily adaptable to numerous applications such as wellness monitoring, emergency medical treatment, financial planning, an informational resource system, inventory management, management of service providers, as well as other suitable applications. Generally, this system includes a data acquisition device that collects various types of data. The versatile data acquisition device can collect data in a variety of ways. An input device, within the data acquisition device, can gather spoken information, scanned information, or written information entered with a keypad or a touch sensitive screen. Because the input device can collect spoken information, the data acquisition device enables hands free data collection, which can be particularly advantageous when used in a vehicle. All of these features enable use of the data acquisition device in a host of settings including retail stores, grocery stores, catalogs, pharmacies, and the like.

After collecting the data, the data acquisition device transfers the data to a data accumulation device. Because this device enables the transfer of data between the data acquisition device and a computer system, any one of several devices could function as a data accumulation device. For example, a multipurpose card, such as a smartcard, could function as a data accumulation device. Alternatively, the data accumulation device could be an optical disk, floppy disk, removable RAM, or a personal digital assistant. The plethora of potential data accumulation devices increases the potential widespread use of the computerized information processing and retrieval system.

Finally, a computer system manages the processing of the data and retrieval of additional information. Typically, the computer system includes several applications that actually process the data. For example, these applications may include financial applications, fitness applications, nutritional applications, product comparison applications, as well as others. Consequently, the computer system can process all types of data and generate reports with trending analyses. Using the data acquisition device, data accumulation device and computer system, the computerized information processing and retrieval system can effectively acquire and manipulate data from various sources.

As previously mentioned, the computerized information processing and retrieval system easily adapts into a wellness monitoring system that can track fitness, nutrition, medicine, blood-lipid levels, as well as other values. Using the input device of the data acquisition device simplifies the data collection procedure and aids in effective recording of daily dietary intake. For example, an individual can quickly scan the nutritional information from a frozen meal eaten during lunch. After storing the data on a data accumulation device, the computer system can access the data. In processing the data, the computer system could compare the individual's monthly performance with an ideal wellness program. The generated report could include future recommendations, such as “Do not exercise until your sugar level is below 250”. As a result, the individual receives a progress evaluation. This evaluation can serve as a source of motivation for continued compliance with a physician's regimen. Using the computerized information processing and retrieval system as a wellness monitoring system advantageously supplies an individual with a resident nutritionist, physical trainer, pharmacist and physician that can dynamically evaluate wellness.

The computerized information processing and retrieval system also easily adapts into an effective medical treatment system. In this application, the data accumulation device can store medically relevant information such as a patient's photo, name, blood type, physician's name, relatives, or present medical condition. When a smartcard functions as the data accumulation device, this medical information can be pre-stored in a secure area separate from other data. During an emergency, medical professionals can insert the smartcard into a data acquisition device that includes a display. When the data acquisition device includes the password used in securing the medical data, the data acquisition device can display this medical data on a screen. The computer system displays the medically relevant information on a screen. In response, medical personnel can prescribe the effective dosage and type of medicine. For example, medical personnel could avoid medicines that could invoke an allergic reaction from the patient. Consequently, they could stabilize the patient faster. Using the computerized information processing and retrieval system, as an emergency medical treatment system, revolutionizes modern medical treatment by removing some of the speculation that can be particularly critical when a patient is unconscious.

Another application of the computerized information processing and retrieval system includes an informational resource system. The input device of the data acquisition device efficiently records information using an informational identifier. For example, an individual could speak a company's ticker symbol or an educational institution's federal school code into the data acquisition device. In response, the data acquisition device can store the information on the data accumulation device. Using a local application, the computer system can retrieve detailed information associated with the informational identifier. For example, the computer system may retrieve business headlines for the company identified by the ticker symbol. The computer system could also generate a report on the educational institution that highlights admission requirements. As an informational resource system, the computerized information processing and retrieval system provides a user with a detailed report without laborious research.

Generally described, a wellness monitoring system for tracking the health of a user includes a data acquisition device with an input device for receiving qualitative wellness data and quantitative wellness data. The wellness monitoring system also includes a data accumulation device for temporarily storing and transporting the wellness data received from the data acquisition device. A computer system for evaluating the wellness of the user is also included. The computer system reads the wellness data from the data accumulation device, erases the wellness data from the data accumulation device, analyzes the wellness data to evaluate the health of the user, and generates a report for the user that conveys the evaluation.

An informational resource system for acquiring detailed information associated with simple informational identifiers includes a data acquisition device with an input device for receiving a plurality of informational identifiers from a user. The informational resource system also includes a data accumulation device for temporarily storing and transporting the informational identifiers received from the data acquisition device. A computer system for acquiring detailed information for each informational identifier is also included. The computer system reads each informational identifier received from the data accumulation device, processes each informational identifier to determine the location of the detailed information, retrieves the detailed information for each identifier, and generates a report for the user that provides the detailed information associated with each identifier.

An emergency medical treatment system for use in a medical facility or an emergency vehicle includes a data accumulation device that stores and transports medically relevant data for a patient. A data acquisition device that reads the data from a first secure area of the data accumulation device and displays the medical data stored in this first secure area is also included. The data accumulation device also includes a second secure area where non-medical information is stored.

In view of the foregoing, it will be appreciated that the computerized information processing and retrieval system avoids the drawbacks of prior systems. The specific techniques and structures employed by the invention to improve over the drawbacks of the prior systems and accomplish the advantages described above will become apparent from the following detailed description of the embodiments of the invention and the appended drawings and claims.

### BRIEF DESCRIPTION OF THE DRAWINGS

FIG. 1 is a functional block diagram of a computerized information processing and retrieval system.

FIG. 2 is a first alternative embodiment of the system of FIG. 1 for use with a remote secure records maintenance system accessible via the Internet.

FIG. 3 is a logic flow diagram for a second alternative embodiment of the system of FIG. 1 for increasing security of the system by using a second data accumulation device.

FIG. 4A is a functional block diagram illustrating conversion of the system of FIG. 1 into a wellness monitoring system.

FIG. 4B is an enlarged view of the report of FIG. 4A illustrating trending analyses, recommendations, and future goals.

FIG. 4C is a perspective view of an embodiment of the data acquisition device of FIG. 2.

FIG. 5A is a functional block diagram illustrating conversion of the system of FIG. 1 into a medical treatment system.

FIG. 5B is a perspective view of a data acquisition device for use with the emergency medical treatment system of FIG. 5A.

FIG. 6 is a functional block diagram illustrating conversion of the system of FIG. 1 into an informational resource system.

### DETAILED DESCRIPTION OF THE EMBODIMENTS

The present invention may be embodied in a computerized information processing and retrieval system that easily adapts to numerous applications such as wellness monitoring, medical treatment, financial planning, an informational resource system, inventory management, management of service providers, as well as other suitable applications. Generally, this system includes a data acquisition device that collects various types of data. After collecting the data, this device transfers the data to a data accumulation device. The data accumulation device effectively stores and transfers data between digital devices. Finally, a computer system processes the data stored on the data accumulation device, retrieves any relevant information, and produces a report for a user.

The data acquisition device collects various types of data and enables use of the computerized information processing and retrieval system in a variety of settings. With an input device, the data acquisition device can gather spoken information, scanned information, or written information. The input device could be a keypad, touch sensitive screen, voice recognition device, or some other suitable device. In addition, the data acquisition device's design enables integration of this device within a larger device, such as a card reader. Alternatively, the data acquisition device could be portable and attach easily to an individual. Moreover, the data acquisition device effectively collects various types of information including educational information, stock quotes, dietary information, product information, as well as other types of data. Consequently, the data acquisition device can be used in a vehicle, supermarket, school, retail store and a variety of other settings.

Like the data acquisition device, the design of the data accumulation device also enables use in a variety of settings. Primarily the data acquisition device transfers data among digital devices. Hence, the data accumulation device could be a multipurpose card, an optical disk, floppy disk, removable RAM, a personal digital assistant, or some other suitable device. Moreover, the data accumulation device can include security features that limit unauthorized access. When a smartcard is used, the data accumulation device can store personal information, such as product purchases, and an encrypted access code. This code can limit access to designated individuals. Consequently, the data accumulation device can securely receive data from various sources while limiting access to it.

After receiving data from the data accumulation device, the computer system processes the data and retrieves additional information if needed. Typically, the computer system uses applications that actually process the data, such as financial applications, fitness applications, nutritional applications, product comparison applications, as well as others. During processing, the computer system generates reports with qualitative analyses, quantitative analyses, and trending analyses. In addition, the computer system can upgrade its applications or records by connecting to another computer through some communication media, such as the Internet. The computer system can also retrieve additional information needed for processing using the Internet. Together the data acquisition device, data accumulation device, and computer system can effectively acquire and manipulate data from various sources.

When used as a wellness monitoring system, the computerized information and processing system can track fitness, nutrition, medicine, blood-lipid levels, as well as other values. The data acquisition device simplifies data collection and aids in effective recording of daily dietary intake by using an input device. With a scanning wand, an individual can efficiently scan the nutritional information, medicinal information, or the like. Alternatively, an individual can describe side effects while taking a medication using another type of input device, such as a keypad. Consequently, the data acquisition device can record both qualitative data and quantitative data. Once the data accumulation device receives the data, the computer system can access it. In processing the data, the computer system can compare the individual's performance over a designated time period. The computer system produces a report that could include future recommendations, such as “Do not exercise until your sugar level is below 250”. Consequently, the report provides the user with tangible feedback on the results of his efforts and correspondingly improves his health.

The computerized information processing and retrieval system also easily adapts into an effective emergency medical treatment system. The data accumulation device and the computer system enable use of this system in either an emergency vehicle or a medical treatment facility. The data accumulation device stores medically relevant information such as a patient's photo, name, blood type, physician's name, relatives, present medical condition, allergies, or insurance information. Issuing these cards to elderly individuals could include adding a chain that enables suspension of the card around their neck. During an emergency, medical professionals can insert the smartcard into the data acquisition device and avoid the arduous task of requesting this information from observers. Once the data accumulation device is inserted, the computer system displays the medically relevant information on a screen after providing a password. In response, medical personnel can prescribe the effective dosage and avoid medicines that could invoke an allergic reaction from the patient. Consequently, they could stabilize the patient faster. Using a data acquisition device can aid medical personnel in conveying treatment prescribed while in route to a medical facility. This information could be downloaded from an associated computer system to the medical facility before the patient arrives using wireless technology. As a result, medical personnel at a medical facility can prescribe subsequent medical treatment accordingly.

Another application of the computerized information processing and retrieval system includes an informational resource system. The input device of the data acquisition device efficiently records information using an informational identifier. In response, the data acquisition device can store the information on the data accumulation device. Using a local application, the computer system can retrieve detailed information associated with the informational identifier. For example, the computer system may retrieve business headlines for the company identified by a ticker symbol. After retrieving this information, the computer system can notify the user by electronic mail. As an informational resource system, the computerized information processing and retrieval system provides a user with a detailed report without laborious research.

Computerized Information Processing and Retrieval System

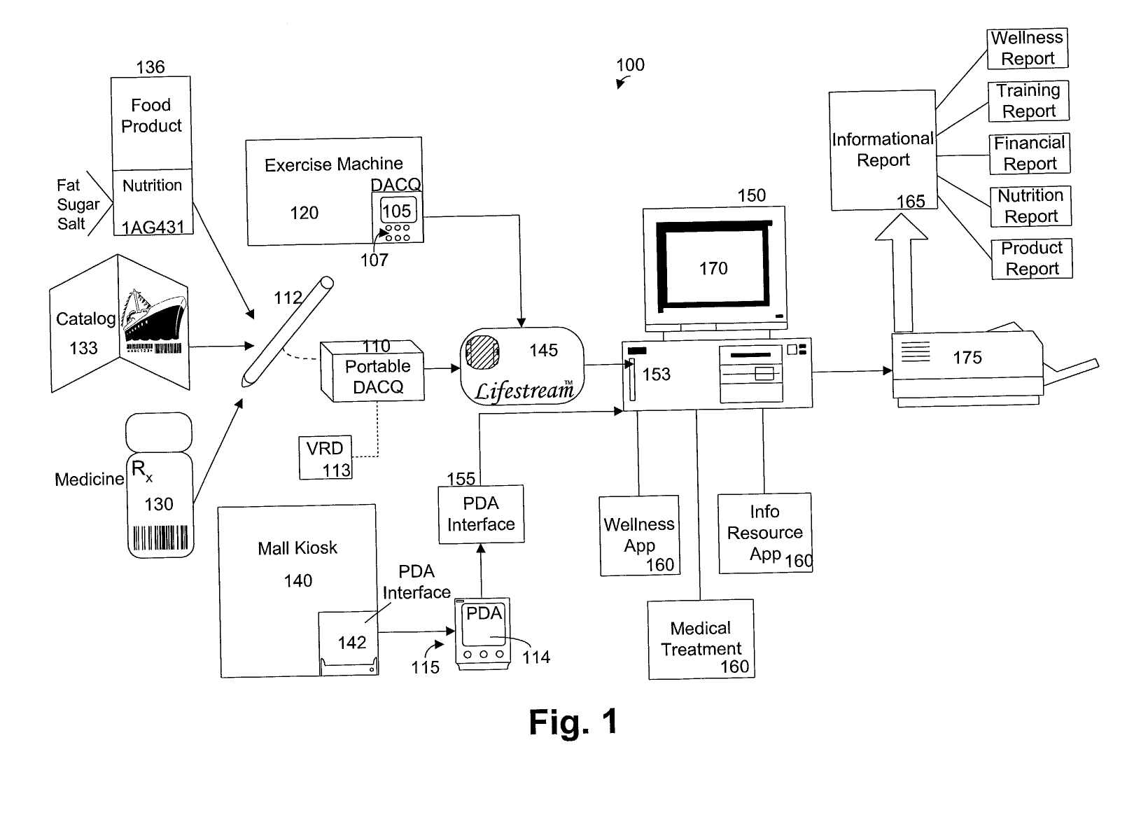

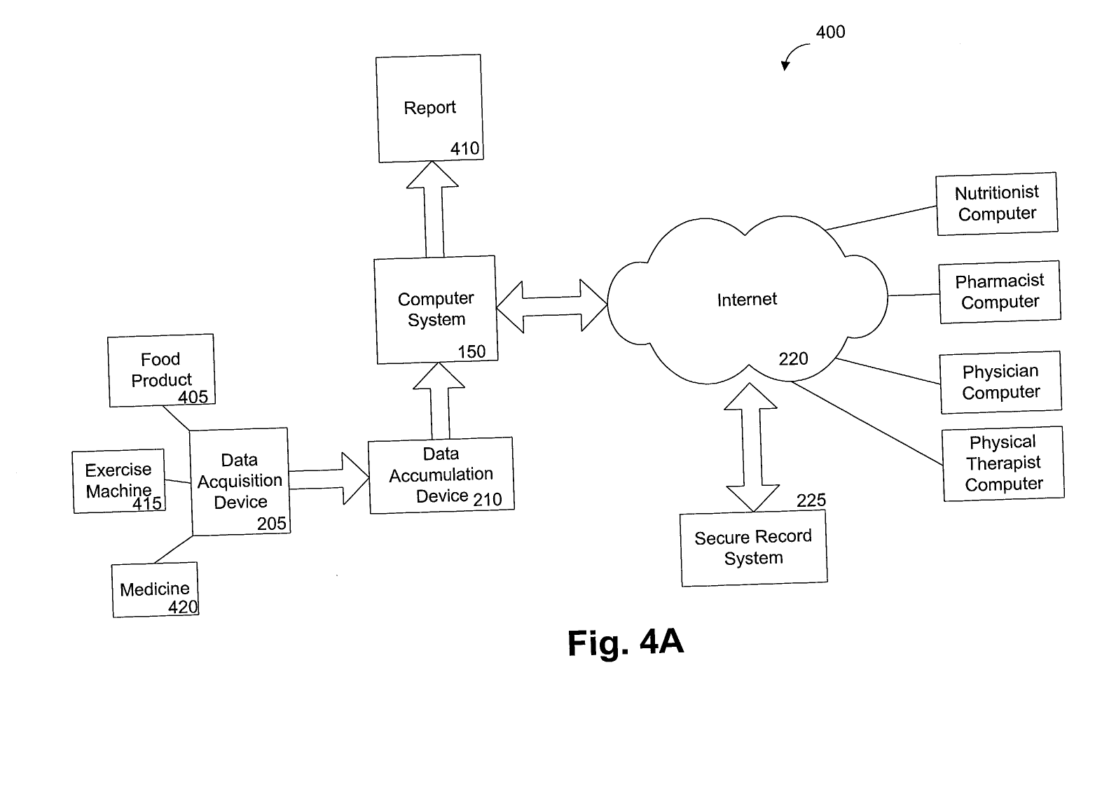

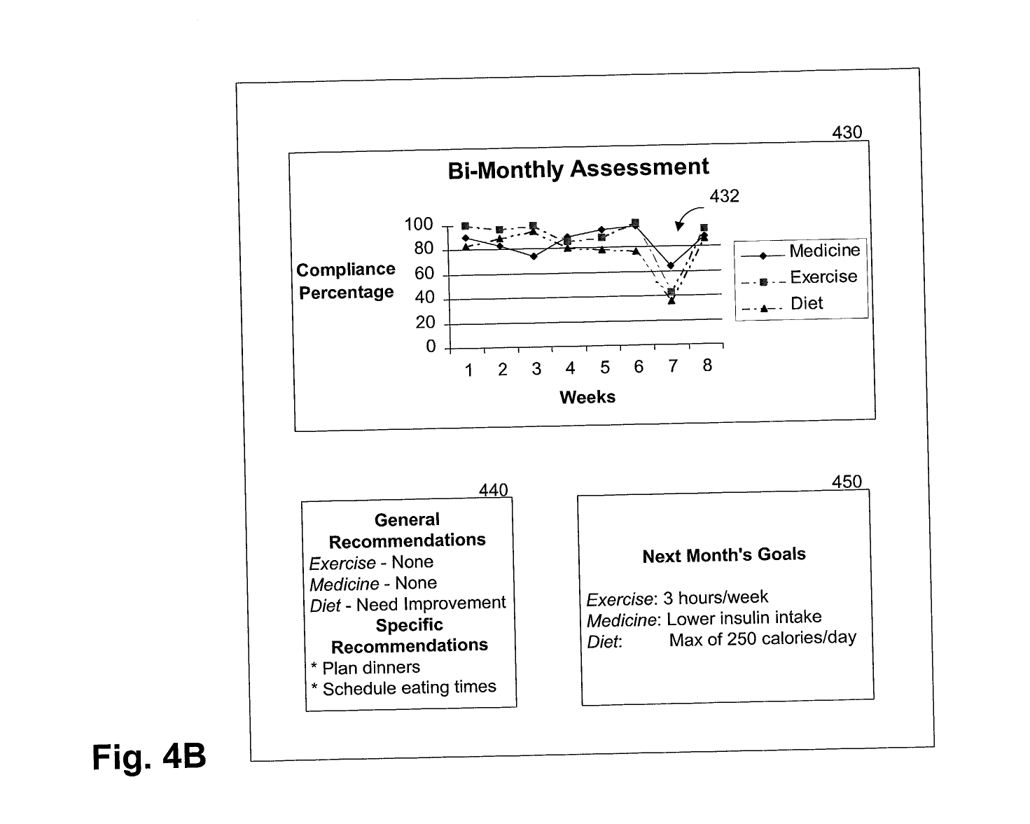

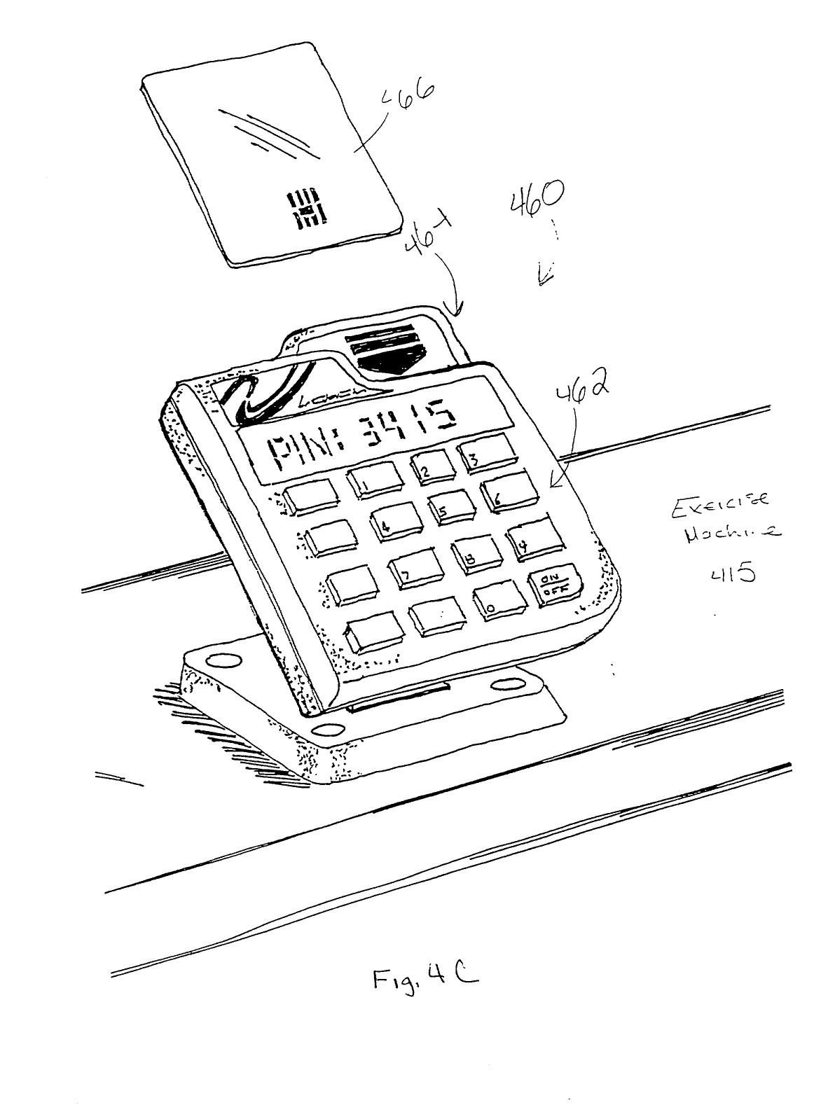

Turning now to the figures, in which like numerals refer to like elements throughout the several figures, FIG. 1 is a functional block diagram of a computerized information processing system 100. This system can be used in wellness monitoring, emergency medical treatment, and as an informational resource system. These applications of the system 100 are explained in greater detail with reference to FIGS. 4-6. Though not illustrated, other applications of the system 100 could include inventory management, financial planning, management of service providers or any other application where collected information is analyzed for trends.

The information processing and retrieval system 100 gathers information using data acquisition devices that can receive both qualitative and quantitative data. This system includes a data acquisition device or DACQ 105, a portable DACQ 110, and a personal digital assistant 115. Typically, the DACQ 105 resides within a larger device, such as an exercise machine 120. As a person exercises, this DACQ collects exercise training information, such as the duration of the exercise program, the number of calories burned, heart rate, and type of exercise. The DACQ 105 can also include an input device in the form of a keypad 107. Using this keypad, a user can enter additional exercise training information such as ideal program duration or physical condition. Though the exercise machine 120 houses the DACQ 105, this DACQ could reside in other devices such as a card reader, pay phone, scale, or a blood pressure machine.

Alternatively, the system 100 could collect information using the portable DACQ 110. The design of this DACQ aids in its use in a variety of settings. For example, it could be small and include a belt clip that enables attachment to an individual's belt. Alternatively, the portable DACQ 110 could be stored in a purse or suspended about a person's neck. A user can remove the DACQ 110 from a storage location and place this DACQ inside a larger device. For example, the exercise machine 120 can include an orifice for securing the portable DACQ 110 when in use. Inserting this DACQ into the orifice electrically couples the portable DACQ 110 to the exercise machine 120 for recording the exercise-training program. As described with reference to the DACQ 105, the portable DACQ 110 can be used with other devices including a scale, card reader, or some other suitable device.

Moreover, the portable DACQ 110 includes an input device that enables its use independent of another device. The input device could be a scanning wand 112, voice recognition device 113, touch-sensitive screen 114, keypad 107, or some combination of these devices. With the scanning wand 112, a user can scan a barcode on a medicine bottle 130, a code regarding a cruise advertised in a catalog 133, or a code on a food product 136. Though, this wand could be tethered to the portable DACQ 110, the scanning wand 112 could transfer the scanned information using wireless radio technology, such as Bluetooth Technology. Scanning the medicine bottle 130 can transfer the recommended dosage, prescription name, and physician. Scanning the cruise page in the catalog 133 can record a source for additional information, such as an article describing the cruise. Similarly, scanning the food product 136 can transfer nutritional information for the product such as caloric content, fat content, sugar content, number of carbohydrates, protein content, and sodium content.

Finally, the computerized information processing system 100 can gather information using a personal digital assistant, or PDA 115. A user can insert information into this PDA using an input device such as the touch-sensitive screen 114. The PDA 115 can collect information from the food product 136 or from the exercise machine 120. Alternatively, the PDA 115 could be used in combination with a kiosk 140 for stress testing, for example. For example, mall shoppers can stop at the kiosk 140 for a stress test. Medical personnel can administer the test and acquire the results using a computer system. This computer system could include a PDA interface 142. An operator could connect the PDA 115 to the interface 142. This connection could transfer the results of the stress test to the PDA 115.

After collecting data with a data acquisition device, the system 100 uses a data accumulation device 145 for storing and transporting the acquired information. This accumulation device could be a removable storage device such as a smart card, an optical disk, a floppy disk, or removable random access memory chip. Removable storage devices such as smart cards typically include an electrical contact for reading and writing data and a small microprocessor, which typically controls security aspects of the smartcard. The microprocessor controls the personal identification number (PIN) and any other functionality resident on the card. If the PIN on the smartcard is a global unique identifier composed of 128 bits, each card can be uniquely identified. In addition, the smartcard could include several secure storage areas each of which is secured by a PIN.

The DACQ 105 and the portable DACQ 110 can include an opening for receiving the data accumulation device 145. This data accumulation device includes a memory storage element that enables effective collection and storage of a designated amount of information. For example, the data accumulation device 145 could store exercise training information from the exercise machine 120, nutritional information from the product 136, information about a cruise from the catalog 133, medicinal information from the bottle 130, and the results of a stress test from the mall kiosk 140. Alternatively, the PDA 115 can serve as both a data acquisition device and a data accumulation device. For example, the PDA 115 can collect information using a touch-sensitive screen and store information using local memory.

Because the data accumulation device 145 is portable, a user can connect to the computer system 150. Typically, this computer system includes a data drive 153 that receives the data accumulation device 145. If this data accumulation device were a smart card, the data drive 153 would be a smart card drive, such as an STM IC:MC33560ADC manufactured by Motorola. Alternatively, the computer system 150 could include an adaptor that receives the smartcard into a typical floppy disk drive. When the PDA 115 functions as a data accumulation device, a PDA interface 155 can connect the PDA 115 to the computer system 150. As this computer system receives the data accumulation device 145, it can read and process the accumulated data using various applications. The type of applications may vary depending on the type of accumulated data. For example, these applications may include a wellness application 160, emergency medical application 160, or an informational resource application 160. Other applications may include a financial application, nutrition application, inventory management application, or the like.

In processing this data using an application, the computer system 150 reads the information stored on the data accumulation device 145. The computer system 150 can store the information that it read in a central data file for later use. As the central data file accumulates information from previous reads, this computer system can use this file in determining trends. For example, a user may record his exercise program on Tuesday and Thursday. By keeping this information in a central location, the computer system 150 can compare the user's performance on Tuesday and Thursday. The computer system 150 also analyzes the data based on the instructions within an application. For example, a wellness application may dictate that the computer system 150 assess wellness by analyzing the user's dietary intake, exercise regimen, and medicinal intake.

Subsequently, the computer system 150 generates an informational report 165 for the user that illustrates the result of the analysis. This computer system can display this report on a screen 170 or automatically print the report using a printer 175. Alternatively, the computer system 150 could fax this report, transmit this report electronically to a preselected electronic mail address, download the information to the user's PDA 115, or transmit the report to the user's digital phone. The content of the report 165 may vary depending on the application used to produce the report. For example, a financial report could include all of the user's expenses associated with purchasing the food product 136, paying for the cruise in the catalog 133, buying medicine 130, paying for the stress test as the kiosk 140, or using the exercise machine 120. In addition, the report 165 could include future recommendations such as restricting vacation expenses to an annual maximum of $2000 per year.

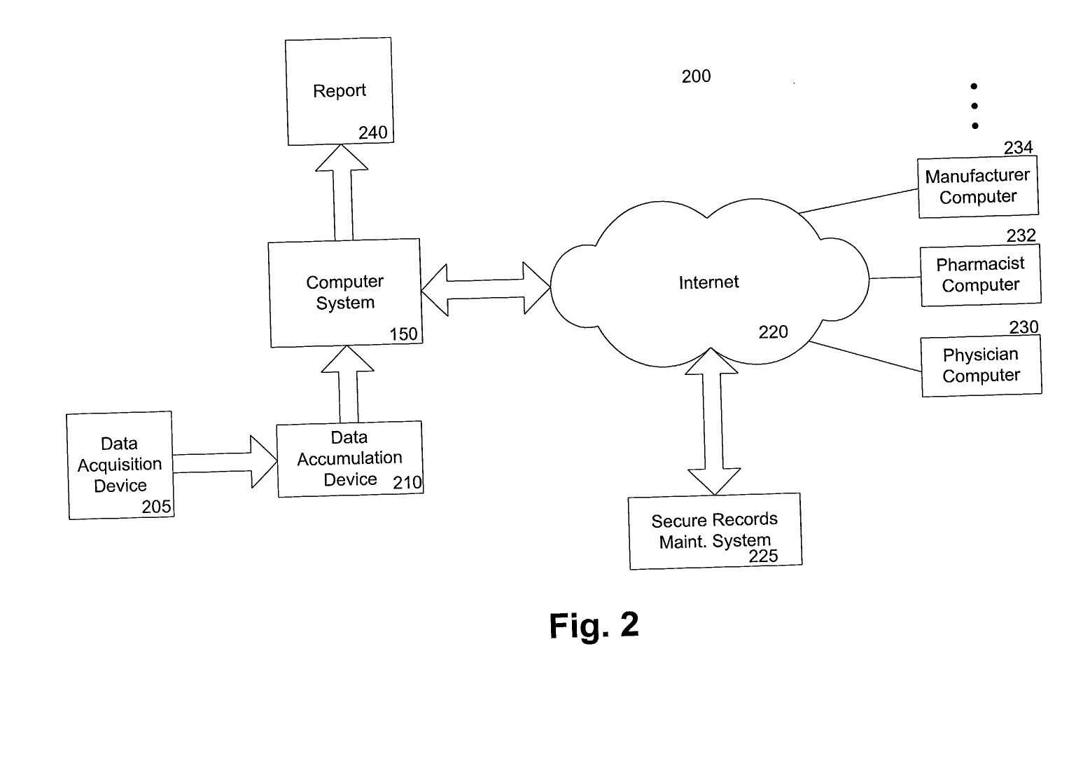

FIG. 2 is a first alternative embodiment of the system 100 for use with a remote secure records maintenance system. The system 200 uses a data acquisition device 205 for collecting data from various sources. This data acquisition device could be the DACQ 105, the portable DACQ 110, the PDA 115, or any other suitable device. After collecting data, the data acquisition device 205 transfers the data to a data accumulation device 210. As previously described with reference to FIG. 1, this device could be the PDA 115 or some type of removable memory storage device 145. The computer system 150 reads the contents of the inserted data accumulation device 210.

As the computer system 150 processes the data received from the data accumulation device 210 using resident application programs, this computer system may request additional information from other sources via the Internet 220. The secure records maintenance system 225 serves as a source of information. It functions similar to the secure medical records maintenance system known as the “PRIVALINK” system and described in commonly-owned U.S. patent application Ser. No. 09/436,323 filed on Nov. 8, 1999 entitled Health Monitoring and Diagnostic Device and Network-Based Health Assessment and Medical Records Maintenance System, which is herein incorporated by reference. Typically, the secure records maintenance system 225 includes two independent servers. Consequently, this secure records maintenance system effectively maintains biographical information on numerous users separate from identifying information without compromising security. For example, the design of the secure records maintenance system 225 substantially hinders a potential hacker from correlating the identification information stored in one server with the biographical information stored in the other server.

Other sources accessible via the Internet 220 include a physician's computer 230, pharmacist's computer 232, and manufacturer's computer 234. Each of these computers could update an individual's record on the secure records maintenance system 225 after entering a requisite password. For example, a manufacturer of a DVD purchased by the user may download to the user's record, in the secure records maintenance system 225, related warranty information. While processing the data received from the data accumulation device 210, the computer system 150 can consider information received from the secure records maintenance system 225 in generating the report 240. By subsequently downloading the user's record, this computer system could compare products. For example, the computer system 150 could gain access to the user's record after transmitting an appropriate password. As a result, the computer system 150 could indicate, on the report 240, that the second DVD purchased by the user cost more and had less of a warranty that the first DVD. In an alternative embodiment, the secure records maintenance system 225 could periodically update the applications and central data file on the computer system 150. This could minimize time spent in connecting to the Internet while analyzing data.

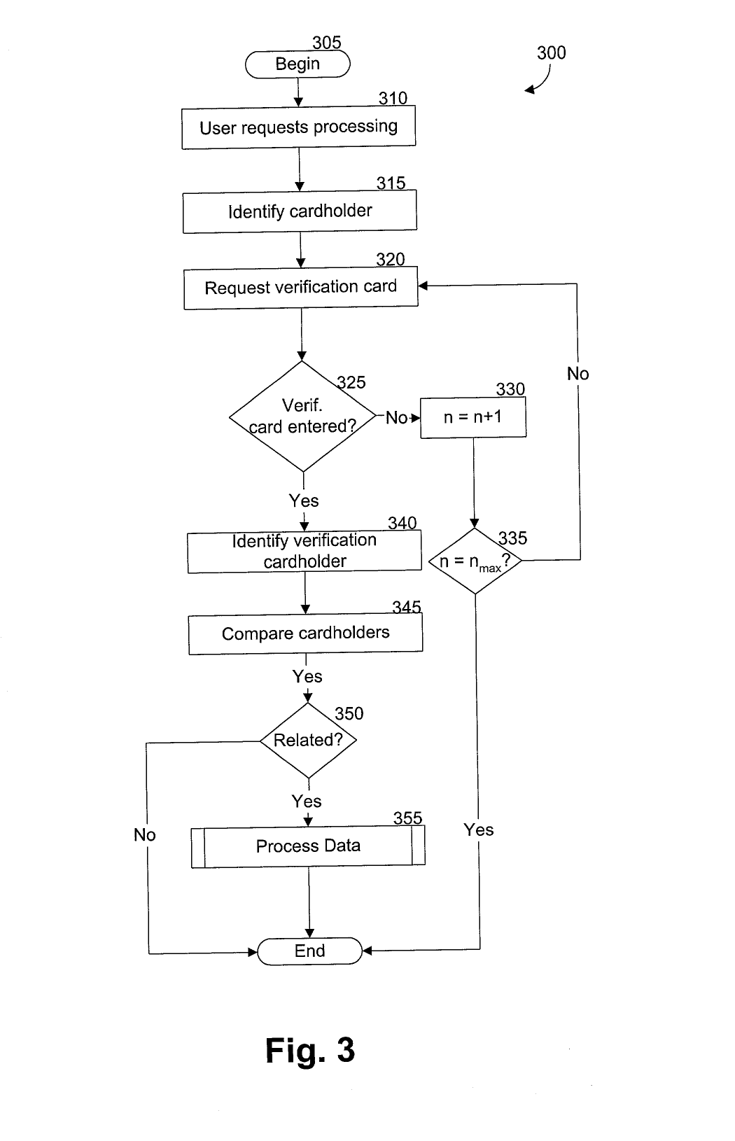

FIG. 3 is a logic flow diagram for a second alternative embodiment of the system 100 for increasing security of the system by using a second data accumulation device. Because the system 100 can collect and analyze medical records, routine 300 helps maintain the privacy of these medical records. Routine 300 begins at step 305. Step 305 is followed by step 310 in which the user requests processing. A user could make this request by starting an application on computer system 150, inserting the data accumulation device 145, activating an icon on a graphic user interface of an application, or some other suitable method. Typically, this request indicates that the user wants the computer system 150 to process the data resident on the data accumulation device 145.

Step 310 is followed by step 315, in which the routine 300 identifies the cardholder. In identifying the cardholder, this routine may use the global unique identifier resident on the smartcard. For example, the routine 300 may use a lookup table to correlate this global unique identifier, or GUID, with an individual. Step 315 is followed by step 325, in which the routine 300 requests a verification card. Initially, each user is given a smartcard and a verification smartcard. Since the verification card also includes a GUID, the routine 300 is essentially demanding that two related GUIDs be received before proceeding further. For example, the GUID processed in step 315 could refer to Jane Q. Doe. Consequently, Jane Q. Doe should be the cardholder of the verification card as well. Alternatively, the verification cardholder could be her doctor, pharmacist, nutritionist, trainer, nurse, or other identified person for coordinated access to the patient's data file.

Step 320 is followed by step 325, in which the routine 300 determines if a verification card was entered. If the verification card was not entered, the “No” branch is followed from step 325 to step 330. In step 330, the routine 300 increments a counter. Step 330 is followed by step 335, in which the routine 300 determines if the counter has reached its maximum value. If the counter has not reached a maximum value, the “No” branch is followed from step 335 to step 320. If the counter has reached its maximum value, the “Yes” branch is followed from step 335 to the “END,” step. Together steps 330 and 335 limit the number of times that the routine 300 requests a verification card. If the verification card is never entered, the computer system 150 never processes the data on the data accumulation device 145. Moreover, the routine 300 could include an additional step between step 335 and the “END” step that erases the data from the data accumulation device 145. Consequently, a thief who steals the data acquisition device 210 cannot retrieve any information without the user's verification card.

If a verification card was entered, the “Yes” branch is followed from step 325 to step 340. In step 340, the routine 300 identifies the cardholder of the verification card. In this step, the routine 300 can also use a lookup table. The Step 340 is followed by step 345, in which the routine 300 compares the cardholders. Step 345 is followed by step 350, in which the routine 300 determines if the cardholders are the same. If the cardholders are related, the “Yes” branch is followed from step 350 to subroutine 355. For example, the routine 300 may consider Jane Q. Doe's nutritionist as related, or associated, to Jane Q. Doe. In subroutine 355, the routine 300 processes the data received from the smartcard, or data acquisition device 210. If the cardholders are not related, the “No” branch is followed from step 350 to the “End” step. Again, the routine does not process the data on the smartcard, unless the identities of the cardholders relate.

In another alternative embodiment, the routine 300 could include an additional step between step 350 and the “END” step, in which this routine erases the data stored on the smartcard, or data accumulation device. Consequently, unauthorized individuals that lacked the requisite verification card could be denied access to the data on the data accumulation device 210 after inserting it into the computer system 150. Though the routine 300 applies directly to data accumulation devices that are smartcards, a similar routine can be generated when the PDA 115 is used as a data acquisition device. Another embodiment could result when the routine 300 grants access to the data without a verification card, but demands a verification card for updating the user's record. In this embodiment, a cardholder that loses his smartcard, can still process the data, but not update the record. In another alternative embodiment, the user could give the verification card to his physician, pharmacist, nutritionist, trainer, nurse, or other identified person. Consequently, the routine 300 could be adjusted such that insertion of the verification card grants access to the data, even in the absence of the smartcard.

Wellness Monitoring System

FIG. 4A is a functional block diagram illustrating conversion of the computerized information processing system 100 into a wellness monitoring system 400. Because individuals often struggle with satisfying physician recommended dietary restrictions, the wellness monitoring system 400 can efficiently record dietary information, medicinal information, and exercise information throughout the day. This wellness monitoring system includes a data acquisition device 205, data accumulation device 210, and computer system 150. Because these devices were described with reference to FIG. 2, that complete description is not repeated here.

The data acquisition device 205 can acquire daily nutritional information from a food product 405, exercise information from an exercise machine 415, and medicinal information 420. For example, a person could scan the dietary information for a box of cereal in the morning and input that they ate one bowl with skim milk. A few hours later, an individual could measure his sugar level and record the subsequent insulin intake. While at the gym, the individual could record his exercise program with the data acquisition device 205. Throughout the day, this data acquisition device stores data on the data accumulation device 210. At the end of the day, this individual could connect the data accumulation device 210 to the computer system 150. This computer system could produce a wellness analysis, or report 410, based on the individual's actions that day.

In an alternative embodiment, the data acquisition device 205 could include logic that dynamically records and displays the total number of calories consumed by the individual. For example, a physician may recommend that an individual consume a maximum of 2000 calories per day. If the data acquisition device indicates that individual has consumed 1800 calories as of 2 p.m., the individual can better plan his meals for the remainder of the day to ensure compliance with the physician's recommendation. In another alternative embodiment, an individual could scan items purchased from the grocery store for nutritional information using the data acquisition device 205. Additional logic in this device could enable the individual to select from a list the item consumed and the associated amount.

In another alternative embodiment of the wellness monitoring system 400, the individual can create a weekly exercise regimen using the computer system 150. After a week's time, this computer system could assess compliance with the weekly exercise regimen. For example, the individual may indicate that he will jog five miles twice a week and cycle twelve miles once a week. At the end of the week, the computer system 150 could assess if the individual met the goal. In another alternative embodiment, the computer system 150 could send an alert to the individual by email that half the week has passed and the individual has not gone jogging.

Alternatively, the system 400 could include a biofeedback kit for use at home. One such kit could use temperature biofeedback, which assesses the individual's temperature typically at the fingertips. This measurement can be used for relaxation, stress and pain management, arthritis, anxiety, irritable bowel and other applications. Alternatively, the biofeedback kit could include a blood pressure cuff and a breathing machine. As the biofeedback kit collects information, it stores this data on the data accumulation device 210. After connecting the data accumulation device 210 to the computer system 150, this computer system can indicate the individual's level of relaxation, for example, in the report 410. As previously described with reference to FIG. 1, the system 400 can receive information regarding stress management from a mall kiosk.

The wellness monitoring system 400 can also utilize additional resources available through the Internet 220. The computer system 150 could access the secure records maintenance system 225 via the Internet 220. As previously described with reference to FIG. 2, this record system could include medically relevant information for the individual. For example, the physical therapist's computer may download to the secure records maintenance system 225 a detail description of the recommended exercise regimen. As the computer system 150 downloads the individual's record, this computer system can compare the recommended exercise regimen to the actual exercise regimen. The computer system may issue an alert if the individual did not satisfy the recommended exercise regimen. Though not described, the system 400 may utilize information from the nutritionist computer, pharmacist computer and physician computer in a similar manner. For example, a physician could access an individual's record in the secure records maintenance system 225 prior to his next appointment or update his records to reflect results of his blood tests. Consequently, the computer system 150 can produce a substantially detailed report 410.

FIG. 4B is an enlarged view of the report 410 illustrating trending analyses, future recommendations, and future goals. The report 410 includes a first window 430 that graphically illustrates the individual's performance over a two-month span. The computer system 150 calculates a compliance percentage by comparing the individual's actual performance to the targeted performance. For example, the individual's physician may recommend four hours of exercise per week. Exercising only two hours per week produces a compliance percentage of fifty percent. In contrast, exercising three and a half hours per week produces a compliance percentage of approximately eighty eight percent.

By plotting medicinal compliance, exercise compliance, and dietary compliance, against the number of weeks, the individual can effectively monitor progress. For example, the graph 432 indicates that the dietary compliance generally remained lower than the medicinal compliance and exercise compliance. Hence, an individual can easily conclude that the exercise regimen is more effective than the dietary regimen. While the graph 432 indicates a bimonthly assessment, the computer 150 could easily calculate weekly assessment, bi-weekly assessment, monthly assessment, or any user designated time frame. In addition, the computer 150 could produce a detailed graph of the individual's exercise performance that includes the duration of daily exercise, number of calories “burned,” type of exercise, number of repetitions, and any other relevant exercise factor. The computer could also produce similar detailed graphs for other types of information such as medicinal intake, dietary intake, and medical condition measurements.

In addition, the report 410 could include a recommendation window 440 and a future goal window 450. The recommendation window 440 could include a general recommendation section that clearly identifies areas that need improvement. In the specific recommendation section, the computer 150 can indicate detailed recommendations that the individual should try accomplishing that will aid in achieving the general recommendation. For example, this computer could recommend that the individual improve his diet by planning his dinners and scheduling his eating times. In the goal window 450, the computer 150 can outline specific goals for the next monitoring period, such as only intake 250 calories per day.

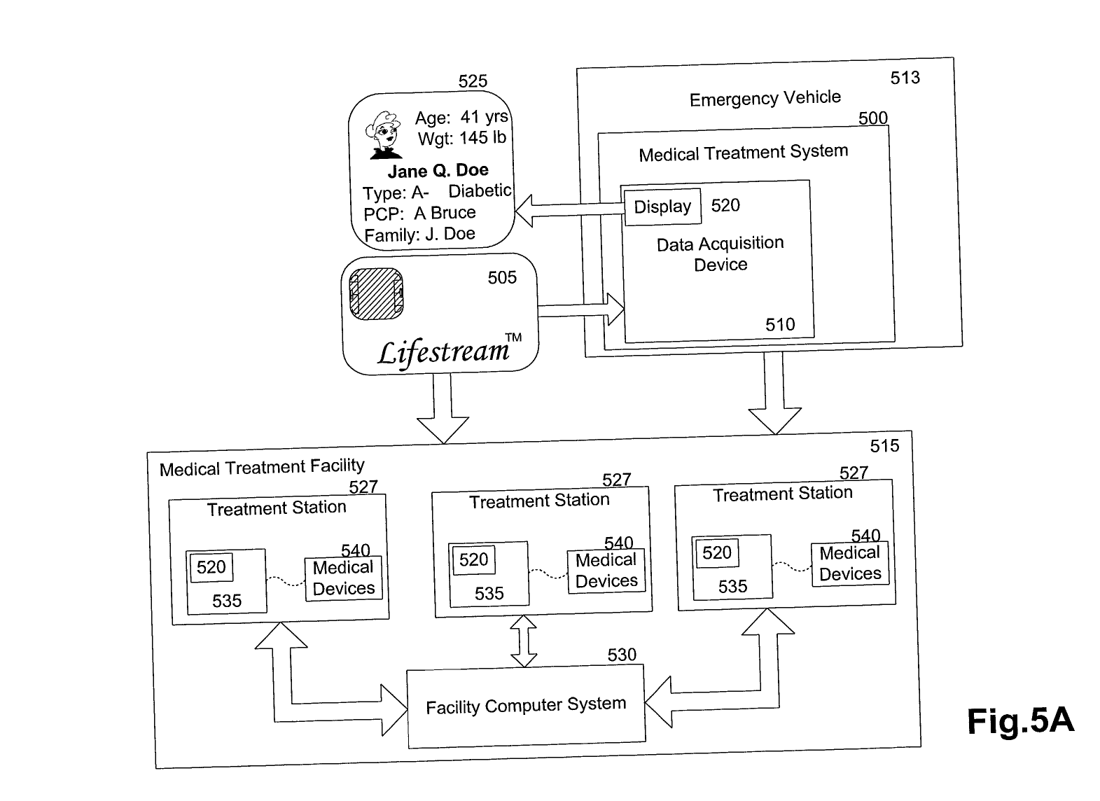

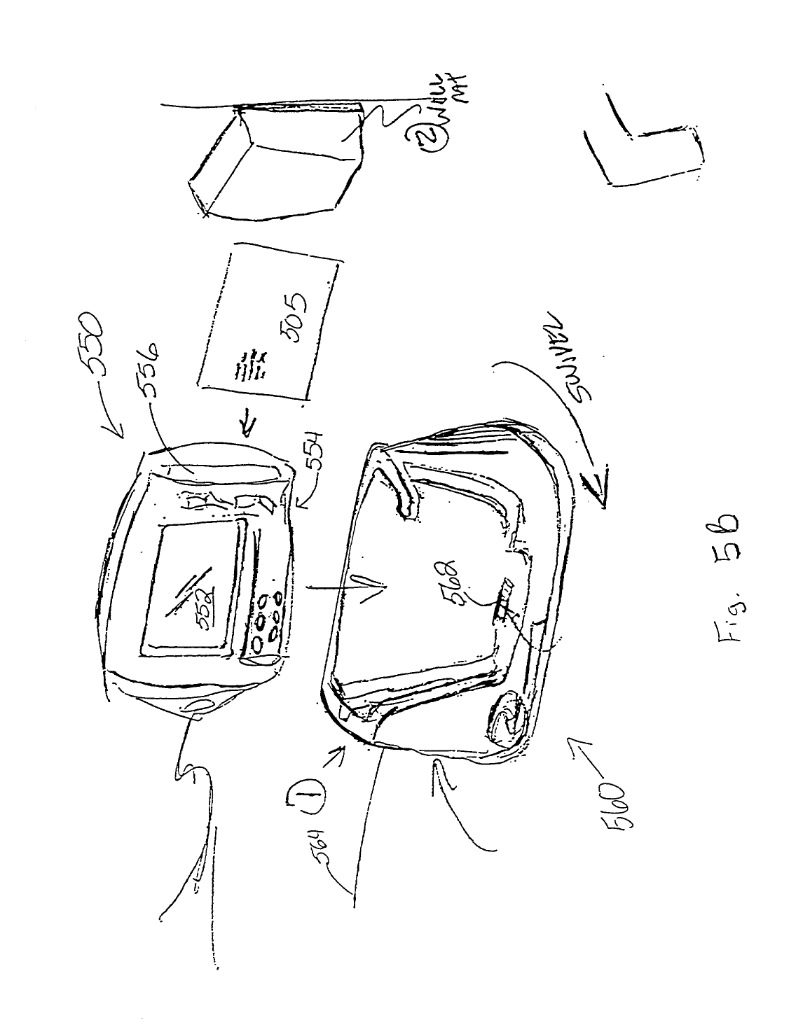

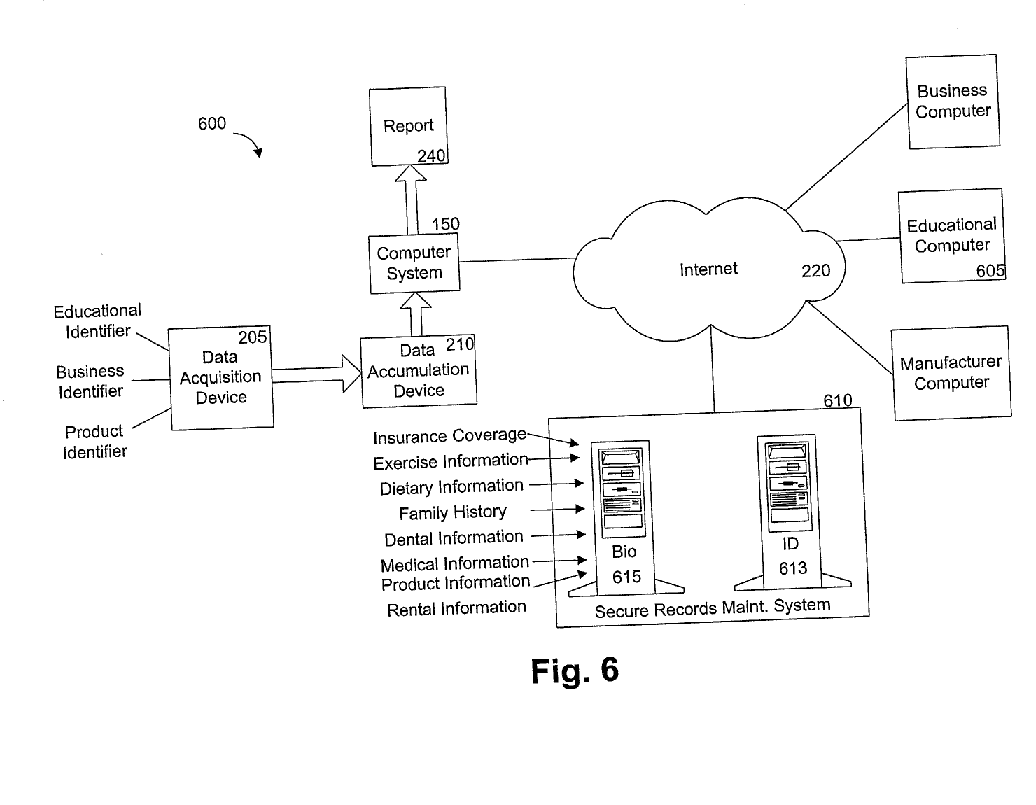

FIG. 4C is a perspective view of an embodiment of the data acquisition device 205. The data acquisition device 460 can mount to the exercise machine 415 or some other type of device. The device 460 includes a keypad 462 and card reader 464 for receiving a multipurpose smartcard 466. Using this keypad, a user can enter the number of calories “burned,” duration of exercise program, and maximum heart rate, for example. The data acquisition device 460 transfers this data to the multipurpose smartcard 466 for temporary storage. Though described with reference to the wellness monitoring system 400, the data acquisition device 460 can also be used in the emergency medical treatment system described with reference to FIG. 5A or the informational resource system described with reference to FIG. 6.

Medical Treatment System

FIG. 5A is a functional block diagram illustrating conversion of the computerized information processing system 100 into an emergency medical treatment system 500. During emergency medical treatment, a patient's medical condition often inhibits medical personnel from retrieving critical medical information. The emergency medical treatment system 500 overcomes this obstacle using a data accumulation device 210, or smartcard 505, in combination with a data acquisition device 510. These simple components enable use of the system 500 in either an emergency vehicle 513 or a medical treatment facility 515. Alternatively, medical personnel could use a portable version of the system 500 during home health visits.

To use the medical treatment system 500, an individual stores medically relevant information onto the smartcard 505. Some examples of medically relevant information include the person's name, photograph, age, weight, blood type, physician's name, relative's name, present medical conditions, organ donor status, existence of a living will, fingerprint, DNA, insurance, medical history and date of last update. Individuals could receive previously programmed smartcards. This smartcard could include a first area secured by a global unique identifier (GUID) that includes various types of non-medical information, as described with reference to FIG. 6. However, this card could also include a second area secured by a GUID that contains the medical information described above. Medical professionals may possess the second GUID that allows them access to the medically relevant information stored on the smartcard 505. As mentioned above, the PDA 115 as well as any other removable memory storage device could also function as a data accumulation device and be used with the treatment system 500. Individuals can store the smartcard 505 on a necklace, in a wallet or purse.

When using the emergency medical treatment system 500 with an emergency vehicle 513, medical personnel can acquire the smartcard 505 from about the patient's neck, for example. Subsequently, they can insert this card into the data acquisition device 510. This data acquisition device could include a notebook computer. Using a notebook computer could minimize the physical dimensions required for the medical treatment system 500, which can be a considerable factor in emergency vehicles. After receiving the smartcard 505, the data acquisition device 510 could read and display the data stored on the card using the computer system's display 520. Screen 525 indicates the contents of the display 520.

Armed with the information displayed on the screen 525, medical personnel can more effectively treat the patient. For example, medical personnel can begin calling an unconscious person by his name. In addition, knowing the patient's weight aides in prescribing the appropriate medicine dosage. Moreover, knowing present medicine conditions eliminates unknowingly giving potentially harmful medicines. In an alternative embodiment, the data acquisition device 510 could be fortified for use in emergency aircrafts or combat fields. In another alternative embodiment, this data acquisition device includes an input device, such as a voice recognition device, touch-sensitive screen, or a keypad. Paramedics, for example, could verbally indicate the treatment administered in route to a medical facility. In response, an associated computer system could update the smartcard 525 to reflect the latest treatment. Alternatively, this computer system can transfer the information to a medical facility using wireless technology.

When using the emergency medical treatment system 500 with a medical treatment facility 515, medical personnel can also acquire the smartcard 505 from a wallet or about the patient's neck. Because the medical facility may include several treatment stations 527 and a central computer system 530, cost efficiency may warrant that the data acquisition device 535 differ from the data acquisition device 510 used with an emergency vehicle 505. For example, the data acquisition device 535 may not include a computer system but a connection to the computer system 530. Consequently, the facility computer system 530 can analyze data received from the data acquisition device 535. In this manner, each treatment station 527 can download information to the facility computer system 530.

As medical personnel treat the patient, they may use the medical devices 540. These devices could connect to the data acquisition device 535. In this manner, device readings discovered during treatment can be recorded. Because the data acquisition device 535 connects to the facility computer system 530, this computer system 530 can easily access information gathered by the data acquisition device 535. Thus, the facility computer system 530 could send recommendations to the data acquisition device 535. For example, computer system 530 could transmit recent patient information such as results of blood tests, x-rays, ultrasounds, or the like. Moreover, this facility computer system could receive the treatment data administered by medical professionals from the emergency vehicle 513. Consequently, medical professionals can have the most up to date information at their resources during medical treatment.

FIG. 5B is a perspective view of a data acquisition device for use with the emergency medical treatment system of FIG. 5A. The battery operated data acquisition device 550 includes a display 552, keypad 554, and card receptacle 556. Inserting the smartcard 505 into the receptacle 556, displays the medically relevant data such as the patient's photograph on the display 552. Using the keypad 554, medical professionals can scroll through the displayed information. For example, medical professionals can scroll using arrow buttons on this keypad until they identify the patient's weight. The data acquisition device 550 can be suspended from the neck of a medical professional. Moreover, this data acquisition device could include some type of memory storage element that enables duplication of the medical information stored on the smartcard 505.

A cradle 560 connects the data acquisition device 550 to a computer system. For example, the cradle 560 could connect this data acquisition device to the computer system 530 by using the chord 564. Inserting the data acquisition device 550 into the cradle 560 could recharge the battery. Once inserted, the data acquisition device can automatically download information to a connected computer system. For example, the data acquisition device 550 could update the patient's record stored on the computer system 530. In an alternative embodiment, the data acquisition device 550 could include a swivel mount that enables viewing from numerous positions while connected to the cradle 560. In another alternative embodiment, the data acquisition 560 includes an adaptor for mounting to wall.

Informational Resource System

FIG. 6 is a functional block diagram illustrating conversion of the computerized information processing and retrieval system 100 into an informational resource system 600. This system effectively acquires detailed information requested by an individual using a simple informational identifier. The resource system 600 includes a data acquisition device 205, data accumulation device 210, and computer system 150. As mentioned above, these devices are described in detail in reference to FIG. 2 and that complete description is not repeated here. The data acquisition device 205 includes an input device that can receive informational identifiers from the user.

Generally, these informational identifiers serve as pointers that indicate where an individual can acquire additional information. Some types of identifiers could include product identifiers, business identifiers, educational identifiers, or financial identifiers. For example, business identifiers may include a ticker symbol or a company's information line. Examples of educational identifiers include the educational institution's web address or federal school code. The actual identifiers could be numeric codes, bar codes, uniform resource locators, or the like.

Users of the system 600 can easily record these informational identifiers using the data acquisition device 205. As mentioned above, the data acquisition device 205 includes an input device such as a voice recognition device, keypad, touch sensitive screen, scanning wand, or the like. Consequently, the input device could be an 8-Bit voice recognition device manufactured by Centry Semiconductor. As a result, an individual that notices a particular billboard while traveling may speak the informational identifier into the voice recognition device. After converting the individual's spoken words into electronic data, the data acquisition device 205 can store the informational identifier on the data accumulation device 210. As the individual continues speaking informational identifiers into this data acquisition device, the data accumulation device 210 continues collecting these informational identifiers.

After collecting the informational identifiers on the data accumulation device 210, an individual can insert this data accumulation device into the computer system 150. Typically, this computer system includes an application program that processes the informational identifiers stored on the data accumulation device 210. This processing may include reading the informational identifiers, storing them in a central data file, processing the informational identifiers, and identifying a source of additional information. Alternatively, a remote computer system accessible via the Internet 220 could oversee the task of processing the informational identifier. Processing the information identifier can result in determining the source of additional information. After identifying the source, the computer system 150 may either automatically acquire additional information or await a request from the individual.

In acquiring additional information, the computer system 150 could also use the Internet 220. For example, an educational identifier that corresponds to the educational institution's web address could direct the computer system 150 to the educational computer 605. Similarly, a business identifier could direct the computer system 150 to the business' computer and a product identifier could direct the computer system 150 to the manufacturer's computer. The computer system 150 could save a link to this institution's website and notify the individual that additional information is now available for this educational institution. In response, the user could review related information at his leisure without having to search extensively for information on an educational institution discussed during a brief encounter with someone.

The system 600 can also use a remote secure records maintenance system 610 for tracking user requested information. The secure records maintenance system 610 functions similar to the secure records maintenance system 225 in that it includes two independent, yet related servers. Server 613 includes identification information for all users, while server 615 includes biographical information for all users. Some examples of biographical information include insurance coverage, exercise information, dietary information, family history, dental information, medical information, product information, and rental information. Medical information could include allergies and information regarding medical products such as a glucose pump, cholesterol meter, asthma pump, or the like. Consequently, the record system 610 can effectively store various kinds of user-specific information.

When using the secure records maintenance system 610 with the informational resource system 600, the computer system 150 can access a user's record. For example, the computer system 150 could determine if the secure records maintenance system 610 contains the information requested by the individual. If not, this computer system could retrieve the appropriate link based on the informational identifier, as described above. After retrieving the appropriate link, the computer system 150 can update the individual's record in the secure records maintenance system 610 to include the link. Consequently, this system can serve as a remote source of information for the individual. As a remote source, the secure records maintenance system 610 is more easily available to the user without taking up additional hard disk space on the computer system 150. Though shown with the informational resource system 600, this secure records maintenance system applies equally to other types of systems. For example, the secure records maintenance system 610 can be used with the wellness monitoring system 400 or the emergency medical treatment system 500.

In view of the foregoing, it will be appreciated that the present invention provides a computerized information processing and retrieval system that includes components easily adaptable to numerous applications including a wellness monitoring system, emergency medical treatment system, and an informational resource system. It should be understood that the foregoing relates only to the exemplary embodiments of the present invention, and that numerous changes may be made therein without departing from the spirit and scope of the invention as defined by the following claims.

The invention claimed is:

1. A wellness monitoring system for tracking the health of a user, comprising:
a data acquisition device having an input device for receiving qualitative wellness data and quantitative wellness data;
a data accumulation device for temporarily storing and transporting the wellness data received from the data acquisition device; and
a computer system for evaluating the wellness of the user, the computer system operable for reading the wellness data from the data accumulation device, erasing the wellness data from the data accumulation device, analyzing the wellness data to evaluate the health of the user, and generating a report for the user that conveys the evaluation.

2. The wellness system of claim 1, wherein the input device is an input device selected from the group consisting of a keypad, a voice recognition device, a scanning wand, and a touch-sensitive screen.

3. The wellness system of claim 1, wherein:
the data acquisition device is portable and attachable to the user; and
the data accumulation device is a device selected from the group consisting of a smart card and a personal digital assistant.

4. The wellness system of claim 1, wherein:
the computer system stores the wellness data in a central data file associated with the user; and
the computer system updates the content of the data file after generating the report.

5. The wellness system of claim 1, wherein:
the wellness data is dietary intake data;
the dietary intake data is entered using an input device of the data acquisition device; and
the data acquisition device stores the dietary intake data on the data accumulation device.

6. The wellness system of claim 5, wherein the dietary intake data includes data selected from the group consisting of caloric content, fat content, sugar content, salt content, and medicinal information.

7. The wellness system of claim 1, wherein:
the wellness data is exercise-training data;
the exercise training data is entered on the input device of the data acquisition device; and
the data acquisition device stores the exercise training data on the data accumulation device.

8. The wellness system of claim 7 wherein the exercise training data includes the type of exercise, duration of the exercise program, and number of calories burned.

9. The wellness system of claim 1, wherein:
the wellness system further includes a remote secure records maintenance system for providing additional medical information associated with the user to the computer system; and
the secure records maintenance system includes a plurality of removable memory storage devices, each operable for storing data for an associated user, a user-specified personal identification number, and a medical records identification number secured by the user-specified personal identification number, a first remote server operable for storing user identification information indexed by user identification numbers, a second remote server operable for storing user medical data indexed by the medical records identification numbers, and the medical data maintained in the second remote server cannot be correlated to the associated user identification information maintained in the first remote server based on the information contained in the first and second remote servers.

10. The wellness system of claim 9 wherein the secure records maintenance system updates an application on the computer system that analyzes the wellness information.

11. The wellness system of claim 1, wherein:
the wellness system further comprises a second data accumulation device having a user verification number; and
the computer system requests that the user enter the second data accumulation device into the computer system and processes the user verification number before the computer system analyzes the wellness data.

12. An informational resource system for acquiring detailed information associated informational identifiers, comprising:
a data acquisition device having an input device for receiving a plurality of informational identifiers from a user;
a data accumulation device for temporarily storing and transporting the informational identifiers received from the data acquisition device; and
a computer system for acquiring detailed information for each informational identifier, the computer system operable for reading each informational identifier received from the data accumulation device, processing each informational identifier to determine the location of the detailed information, retrieving the detailed information for each identifier, and generating a report for the user that provides the detailed information for each identifier.

13. The informational resource system of claim 12 wherein the informational identifier is an identifier selected from the group consisting of a bar code, uniform resource locator, and a numeric code.

14. The informational resource system of claim 12 wherein the detailed information is information selected from the group consisting of product information, business information, and education information.

15. The informational resource system of claim 14, wherein:
the product information includes a description of the product, product price, and manufacturer;
the business information includes financial history, stock prices, and recent business developments; and
the educational information includes admission requirements, admission deadlines, educational curriculum, and contact information.

16. The informational resource system of claim 12 wherein the computer system retrieves the detailed information by accessing a remote records maintenance system.

17. The informational resource system of claim 12 further comprising a secure records maintenance server comprising:
a plurality of removable memory storage devices, each operable for storing data for an associated user, a user-specified personal identification number, and a records identification number secured by the user-specified personal identification number;
a first remote server operable for storing user identification information indexed user identification numbers;
a second remote server operable for storing various types of data for the user, such that each type of data is indexed by the records identification numbers; and
the data maintained in the second remote server cannot be correlated to the user identification information maintained in the first remote server based on the information contained in the first and second remote servers.

18. The secure records maintenance system of claim 17 wherein the types of data include medical data, dental data, insurance data, exercise data, dietary data, family history data, product data, rental data, and mortgage data.

19. An emergency medical treatment system for use in a medical facility or an emergency vehicle, comprising:
a data accumulation device for storing and transporting medically relevant data for a patient in a first area secured by a first access code;
a data acquisition device for reading the data from the data accumulation device and displaying the medical data stored in the first area of the data accumulation device; wherein
the data accumulation device includes a second area secured by a second access code and the first access code is available to emergency medical personnel.

20. The emergency medical system of claim 17, wherein:
the data acquisition device further comprises a computer system for receiving the treatment data associated with treatment administered by emergency personnel;
the computer system further comprises a display for showing the medical data stored on the data accumulation device; and
the computer system updates the data on the data accumulation device to reflect the medical treatment administered to the patient.

21. The emergency medical system of claim 20 wherein the computer system stores data read from the data accumulation device in a central data file on the computer system.

22. The emergency medical system of claim 20, wherein the computer system analyzes the medical data in the central data file to determine the recommended treatment, and displays the recommended treatment to medical personnel; and

23. The emergency medical system of claim 17, wherein the data on the data accumulation device includes data selected from the group consisting of personal information, blood type, allergies, and medical conditions.

24. The emergency medical system of claim 21 wherein personal information includes information selected from the group consisting of a photograph of the patient, the patient's name, the patient's age, and the patient's weight.
